(19) United States
(12) Patent Application Publication
(10) Pub. No.: US 2002/0111747 A1
(43) Pub. Date: Aug. 15, 2002

(54) System and process for analysis

(76) Inventors: Akira Nishina, Tokyo (JP); Tsutomu Kikuchi, Tokyo (JP); Tetsuya Kimijima, Tokyo (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/057,977

(22) Filed: Jan. 29, 2002

(30) Foreign Application Priority Data
Feb. 15, 2001 (JP) 2001-039188

(51) Int. Cl. G06F 19/00

(52) U.S. Cl. 702/24

(57) ABSTRACT

The present invention provides an analysis system and analysis method for constantly monitoring gases, characterized in that in case there occurs a data discrepancy in an analyzer, the constant and continuous monitoring condition can be backed up while examining the cause of the problem can be carried out at the same time.

Each of the sample introduction portions of the analyzers 11, 21, 31 for analyzing the gases from the respective sampling points 10a, 20a, 30a is provided with a route switching unit such as 3-way valve or 4-way valve 13, 23, 33 or the like.

Using the present system, in case the analytical result is out of range or the analyzer is out of order, by controlling the route switching unit, a gas from an abnormal sampling point can be analyzed in other analyzer continuously or at time intervals.

### BACKGROUND OF THE INVENTION

1. Field of the Invention

The present invention relates to a system and a process for analysis, and more particularly to a system and a process for constantly continuously monitoring and analyzing a plurality of samples by using analyzers corresponding to the samples.

2. Description of the Prior Art

For example, a gas supply system such as an air separation apparatus or an air purification apparatus is provided with an analyzer at a relevant location, for constantly continuously monitoring and analyzing the purity and the impurity amount of the gas to be supplied. A gas using system such as a semiconductor manufacturing system is also designed to perform continuous monitoring analysis of the process gases.

In such cases, if the species of the gas to be supplied or to be used are plural, a plurality of analyzers corresponding to the gases are provided so that each of the sample gases from its corresponding sampling point is collected and supplied to its corresponding analyzer for being subjected to a predetermined analysis therein.

In addition, a gas supply system such as an air separation apparatus often uses an analyzer continuously analyzing impurities in a gas to be supplied at several positions and having inter-lock functions which, in case the amount of impurities is beyond the normal level, shields the gas supply from the air separation apparatus and switches to supply a reservoir gas for backup instead.

In such a case, as the backup gas is just for urgency and thus is limited in amount, it is required to examine and remove causes of the impurity increase, and bring it back to its normal state so that the gas supply from the air separation apparatus may be recovered as soon as possible.

However, as the impurity increase could be resulted from disorder of the analyzer instead of air separation apparatus, it is required to examine whether the out-of-range output for the gas from the analyzer is caused by actually increased impurities in the gas or misinformation of the analyzer.

For such an examination, it is usually required to sample the gas with a sampler, and send the sampler to an analysis laboratory which can analyze the gas precisely.

For such an analysis, however, a vacant and clean sampler should be sent from the laboratory and then be subject to sampling, and then the sampler including the sample gas should be sent back to the laboratory for analysis, which takes at least several days from asking the analysis until obtaining the result.

Further, in the case of the analyzer itself being out of order, it is generally carried out to prepare a same kind of analyzer for substitution and install it instead of the analyzer, so that the substitute analyzer continuously performs the monitoring operation until the disabled analyzer is repaired.

However, it needs a long period of time to obtain, deliver, install and modulate the substitute analyzer, therefore the analysis operation cannot be carried out for several days.

In particular, in the case of semiconductor manufacturing industry in which only a very small amount of impurities in ppb level is allowed in the process gas, a highly sensitive and accurate analyzer which is much more expensive than ordinary analyzers should be used and thus keeping a spare analyzer is not advantageous in an economic point of view.

The restarting of the air separation apparatus often takes around 1 week, although the amount of backup gas usually last one day and thus not sufficient. In such a case, it is required to deliver a liquefied gas from another air separation plant to a reservoir for continuous supply.

As mentioned previously, once a result is out-of range, the air separation apparatus should be stopped for around one week, which requires much trouble and cost. Also, with regard to other gas-using equipments such as semiconductor manufacturing systems, if such a data problem occurs, it takes the same amount time for examining disorder of the analyzer requiring much time and cost.

The present inventors were concerned about the fact that although gas supply system or gas using system as above analyzes a plurality of kinds of gases or analyzes a gas at a plurality of analyzing points, the kinds of impurities are often similar and overlap with one another.

Accordingly, this invention aims to provide an analysis system and an analysis method which can promptly examine whether, in case there occurs a discrepancy in an analyzer, the data discrepancy comes from the analyzer or the gas itself, and in case the analyzer is out of order, can recover the gas supply system or gas using system in a short period of time.

### SUMMARY OF THE INVENTION

According to one aspect of the present invention, there is provided an analysis system comprising: a plurality of analyzers correspondingly mounted to a plurality of sampling points in which samples are respectively analyzed by said corresponding analyzers; analysis routes for introducing the samples from said sampling points into said corresponding analyzers respectively; substitute analysis routes at sending side for sending said samples to analyzers capable of analyzing same kinds of analysis objects as said samples out of said analyzers; route switching means switchably connecting said analysis routes and said substitute analysis routes to said analyzers respectively; substitute analysis route at receiving side being connected to at least one analyzer out of said analyzers and receiving said samples sent from said other analyzers via said route switching means.

In the analysis system, the route switching means is either a 3-way valve or 4-way valve. Also, the substitute analysis route comprises a shutoff valve for shielding itself, and a discharge route communicating from said substitute analysis route to outside of the system and a shutoff valve for shielding said discharge route. Furthermore, the substitute analysis-routes are connected between said analyzers analyzing the samples that do not react with one another.

According to an alternative preferred embodiment of the present invention, there is provided an analysis system comprising: a plurality of analyzers correspondingly mounted to a plurality of sampling points in which samples are respectively analyzed by said corresponding analyzer; a common analyzer being capable of analyzing analysis objects in each of the analyzers; analysis routes for introducing the samples from said sampling points into said corresponding analyzers; substitute analysis routes for introducing said samples into said common analyzer; route switching means switchably connecting said analysis routes and said substitute analysis routes to said analyzers respectively. The common analyzer is further provided with an outer sample introducing route to introduce thereto a sample from the outside, in addition to said substitute analysis routes.

According to another aspect of the present invention, there is provided an analysis method for analyzing each sample from a plurality of sampling points in a plurality of analyzers correspondingly mounted relative to said sampling points, wherein, in case there occurs a discrepancy in an analyzer out of said analyzers, a sample designed to be analyzed by said analyzer is introduced into a substitute analyzer capable of analyzing a same kind of analysis object out of said other analyzers while a substitute analysis is effected by said substitute analyzer. The substitute analyzer alternatively analyzes the sample designed to be analyzed thereby and the sample designed to be analyzed in the analyzer with the discrepancy.

According to an alternative embodiment, there is provided an analysis method for analyzing each sample from a plurality of sampling points in a plurality of analyzers correspondingly mounted relative to said sampling points, wherein a common analyzer capable of analyzing analysis objects of the plurality of analyzers, is further provided in addition to said plurality of analyzers, and the samples to be analyzed in the analyzers are serially switched and introduced into the common analyzer which analyzes the samples switchably. In case there occurs a discrepancy in an analyzer out of said analyzers, the common analyzer preferentially analyzes a sample designed to be analyzed in said analyzer with the discrepancy.

### BRIEF DESCRIPTION OF THE DRAWINGS

For a fuller understanding of the nature and objects of the present invention, references should be made to the following detailed description taken in conjunction with the accompanying drawings in which:

FIG. 1 is a system diagram showing the 1^{st} embodiment of an analysis system according to the present invention.

FIG. 2 is a system diagram exemplifying an analysis method in a normal condition under continuous monitoring analysis.

FIG. 3 is a view similar to that of FIG. 2, in a condition under purge operation.

FIG. 4 is a view similar to that of FIG. 2, in a condition under substitute analysis.

FIG. 5 is a system diagram showing the 2^{nd} embodiment of an analysis system according to the present invention.

FIG. 6 is a system diagram showing the 3^{rd} embodiment of an analysis system according to the present invention.

FIG. 7 is a system diagram showing the 4^{th} embodiment of an analysis system according to the present invention.

### DETAILED DESCRIPTION OF THE PREFFERED EMBODIMENTS

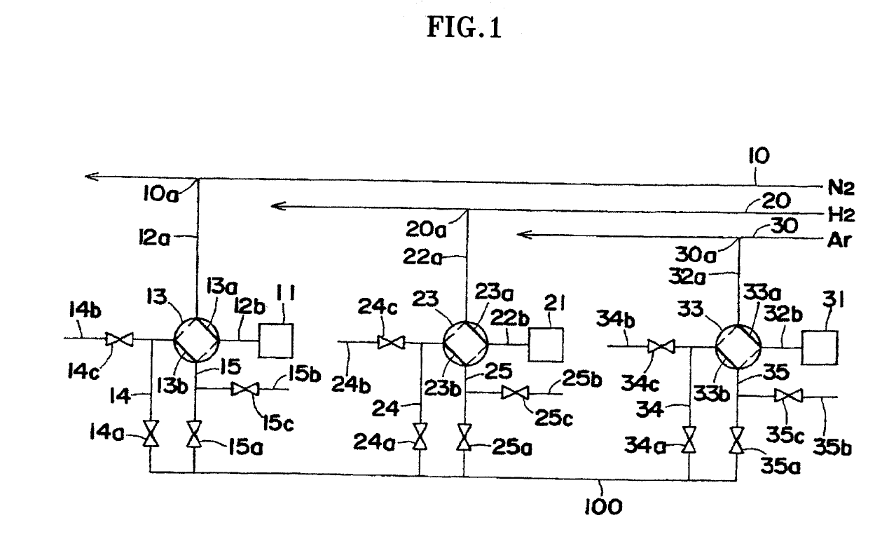

FIG. 1 is a system diagram showing the 1st embodiment of an analysis system according to the present invention.

The analysis system analyzes 3 species of gases, for example, nitrogen (N₂), hydrogen (H₂) and (Ar) purified in a gas purification system, flowing though 3 gas routes 10, 20, 30, in 3 analyzers (an nitrogen analyzer 11, an hydrogen analyzer 21 and an argon analyzer 31), respectively.

In the analysis system, between each of the sampling points 10a, 20a, 30a of the gas routes 10, 20, 30 and each of the analyzers 11, 21, 31, analysis routes 12a, 12b, 22a, 22b, 32a, 32b for introducing the sample sampled in the sampling points 10a, 20a, 30a into the analyzers 11, 21, 31 are respectively formed through 4-way valves 13, 23, 33, each installed at the sample introduction side of the respective analyzers.

The 4-way valves 13, 23, 33 are, in addition to the analysis route, respectively connected to substitute analysis routes 14, 24, 34 at sending side for sending sample to the other analyzers and substitute analysis routes 15, 25, 35 at receiving side for receiving sample from the other analyzers, while the routes 14, 24, 34, 15, 25, 35 are connected to a common substitute analysis route 100, through shutoff valves 14a, 24a, 34a, 15a 25a, 35a, respectively.

The 4-way valves 13, 23, 33 can switch internal pathways 13a, 13b, 23a, 23b, 33a, 33b, and thus can form a route for introducing sample gas sampled to the analysis routes 12a, 22a, 32a from the sampling points 10a, 20a, 30a, into the analyzers 11, 21, 31 through the analysis routes 12b, 22b, 32b respectively, a route for introducing the sample gas sampled to the analysis routes 12a, 22a, 32a, into the substitute analysis routes 14, 24, 34 at sending side respectively, and a route for introducing sample gases received from the other analyzers through the substitute routes 15, 25, 35 at receiving side into the analyzers 11, 21, 31, respectively.

In other words, the above analysis routes communicate with each other via one part of the internal pathways 13a, 23a, 33a, and the substitute analysis routes 14, 24, 34 at sending side communicates with the substitute analysis routes 15, 25, 35 at receiving side, respectively, via the opposite internal pathways 13b, 23b, 33b.

The above analyzers 11, 21, 31 can be selected from any analysis apparatuses if only suitable for the corresponding analysis object. For example, in the case of analyzing a gas purified for use in a semiconductor manufacturing apparatus, an atmosphere pressure ionization mass spectrometer may be used.

As the atmosphere pressure ionization mass spectrometer can analyze almost all components in a gas with high accuracy and sensitivity, the same operation can be applied to nitrogen, hydrogen and argon for impurity analysis.

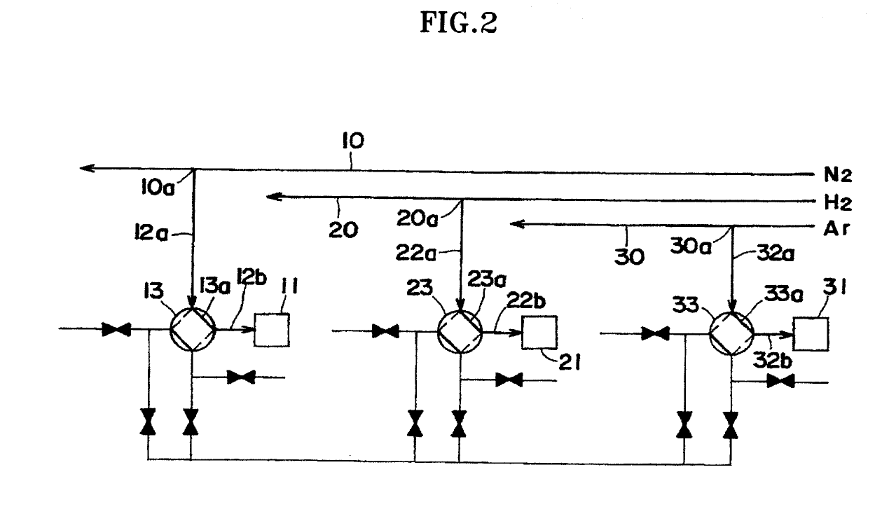

Next, a representative analysis method using the present analysis system, in the case of one analyzer, for example, the hydrogen analyzer 21, being out of order, will be explained based on FIGS. 2 to 4.

In the above figures, the black-marked valves indicate a closed state and the broad line-marked routes indicate a gas flowing state.

At first, FIG. 2 shows the normal state in which the constant continuous monitoring analysis is performed. A part of the nitrogen gas flowing in the gas route 10 flows from the sampling point 10a, through the analysis route 12a and the internal pathway 13a of the 4-way valve 13, into the analysis route 12b, and is then introduced into the nitrogen analyzer 11.

Similarly, a part of the hydrogen gas flowing in the gas route 20 flows from the sampling point 20a through the analysis route 22a and the internal pathway 23a of the 4-way valve 23, into the analysis route 22b, and then is introduced into the hydrogen analyzer 21, and a part of the argon gas flowing in the gas route 30 flows from the sampling point 30a through the analysis route 32a and the internal pathway 33a of the 4-way valve 33, into the analysis route 32b, and is then introduced into the argon analyzer 31.

Accordingly, the analyzers 11, 21, 31 analyze nitrogen, hydrogen and argon, respectively.

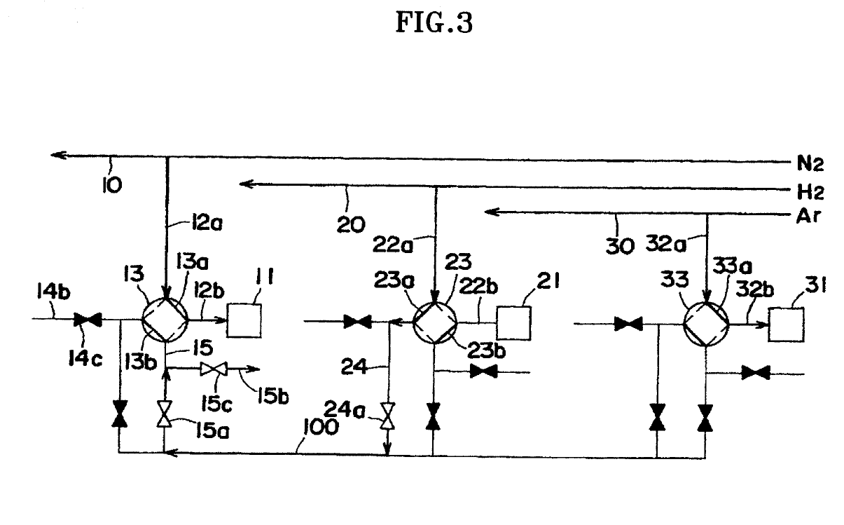

However, as shown in FIG. 3, in case the hydrogen analyzer 21 becomes out of order and does not analyze hydrogen, the pathway of the 4-way valve 23 between the analysis routes 22a, 22b is switched, while the shutoff valve 24a of the substitute analysis route 24 at sending side, the shutoff valve 15a of the substitute analysis route 15 at receiving side annexed to the nitrogen analyzer 11 performing nitrogen analysis, and the shutoff valve 15c of the discharge route 15b are respectively opened, so that the introduction of hydrogen gas into the hydrogen analyzer 21 is stopped and the hydrogen gas sampled into the analysis route 22a from the sampling point 20a of the gas route 20 is discharged into the discharge route 15b through the internal pathway 23a of the 4-way valve 23, the substitute analysis route 24 at sending side, the substitute analysis route 100 and the substitute analysis route 15 at receiving side. As a result, these routes are purged by the flow of hydrogen.

At this time, the nitrogen gas flowing in the gas route 10 flows through the analysis route 12a, the internal pathway 13a of the 4-way valve 13 and the analysis route 12b, into the nitrogen analyzer 11, and is analyzed therein as usual, while the argon gas flowing in the gas route 30 also flows through the analysis route 32a, the internal pathway 33a of the 4-way valve 33 and the analysis route 32b, into the argon analyzer 31, and is then analyzed therein as usual.

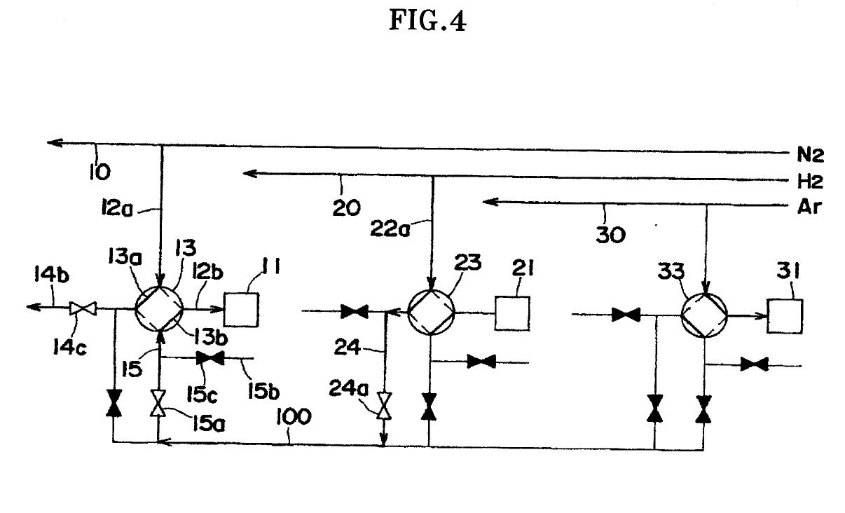

After the route from the substitute analysis route 24 at sending side of the hydrogen analyzer 21 to the substitute analysis route 15 at receiving side of the nitrogen analyzer 11 is sufficiently purged, the 4-way valve 13 of the nitrogen analyzer 11 is switched while the shutoff valve 14c of the discharge route 14b is opened and the shutoff valve 15c of the discharge route 15b is closed, as shown in FIG. 4.

Accordingly, the hydrogen gas which flowed into the substitute analysis route 15 at receiving side from the substitute analysis route 100 flows through the internal pathway 13b of the 4-way valve 13 and the analysis route 12b and is then introduced into the nitrogen analyzer 11.

The system state is switched so that the hydrogen analysis sampled from the gas route 20 to the analysis route 22a, is substituted by the nitrogen analyzer 11, and thus, impurities in the hydrogen gas is analyzed in the nitrogen analyzer 11.

At this state, the nitrogen gas sampled from the gas route 10 to the analysis route 12a, flows through the internal pathway 13a of the 4-way valve 13, the shutoff valve 14c and the discharge route 14b, and is then discharged out of the system. In addition, the argon gas flowing through the gas route 30 is introduced into the argon analyzer 31 and then analyzed therein as usual.

In the substitute analysis state shown in FIG. 4, by switching the 4-way valve 13, the nitrogen gas of the analysis route 12a can be flowed from the internal route 13a of the 4-way valve 13 to the analysis route 12b, and then introduced into the nitrogen analyzer 11, so that the nitrogen analysis is carried out as usual.

As the analysis of nitrogen and the substitute analysis of hydrogen can be switched by operating the 4-way valve, by switching the 4-way valve at a relevant time interval, for example 30 minutes, nitrogen and hydrogen can be analyzed alternatively.

During that time, the disorder of the hydrogen purification apparatus or analyzer is checked, while hydrogen is continuously supplied by using backup gas. If the purity level (amount of impurity) of the hydrogen flowing the gas route 20 is out of range, this indicates that the cause of the data problem lies in the hydrogen purification apparatus itself, and thus, the apparatus is subjected to being repaired.

On the other hand, if there is no problem in the purity level of the hydrogen gas, this means that the hydrogen analyzer is out of order, and thus, the hydrogen analyzer is subjected to being repaired.

When the checking and repairing have been completed, the respective 4-way valves and shutoff valves are switched so that the constant continuous monitoring analysis in the ordinary state of FIG. 1 may be carried out again.

Such operations for substitute analysis may be performed by manually switching the respective 4-way valves and shutoff valves, or may be performed automatically by using a pneumatic valve or an electronic valve that can be controlled externally, in a predetermined sequence.

As explained above, the system can perform substitute analyses only by switching the 4-way valves or the shutoff valves without using the disabled analyzer. Therefore, if one of the analyzers (the hydrogen analyzer 21 in the case of this embodiment) is out of order, the sample to be analyzed in the analyzer (hydrogen gas in the case of this embodiment) is introduced into an analyzer (the nitrogen analyzer 11 in the case of this embodiment) capable of analyzing the same type of sample gas out of the other analyzers, so that the nitrogen analyzer 11 may carry out a substitute analysis for hydrogen. As a result, said hydrogen gas and nitrogen gas can be continuously monitored, analyzed and supplied.

In particular, as the analysis routes can be switched by a 4-way valve as opposed to a plurality of valves, the dead space can be minimized.

Further, the shutoff valves provided in the substitute analysis routes can prevent the sample from flowing into the other analyzers which do not carry out the substitute analysis and the shutoff valves provided in the discharge routes make it possible to purge the routes by the sample sufficiently.

That is, in the purge operation as shown in FIG. 3 where the hydrogen gas introduced into the substitute analysis route 15 at receiving side is discharged through the shutoff valve 15c and the discharge route 15b. Alternatively, however, the hydrogen gas introduced into the substitute analysis route 15 at receiving side can be discharged through the internal pathway 13b of the 4-way valve 13, the shutoff valve 14c and the discharge route 14b, without including the discharge route 15b.

Further, when using an analyzer without an internal calibration system, the calibration of the analyzer, for example the nitrogen analyzer 11, may be carried out by switching the internal pathway 13b of the 4-way valve 13 to the state as shown in FIG. 4, so that the discharge route 15b and the analysis route 12b communicates with each other through the internal pathway 13b of the 4-way valve 13, and then by serially introducing a calibration gas into the nitrogen analyzer 11 from the discharge 15b.

In this case, the respective analyzers can be successively calibrated by only one correction system using the discharge routes 25b, 35b in order, and thus the expensive calibration system can be used for a plurality of analyzers.

For the substitute analyzer, any analyzer can be selected. For example, the substitute analysis for nitrogen can be carried out by either the hydrogen analyzer 21 or the argon analyzer 31.

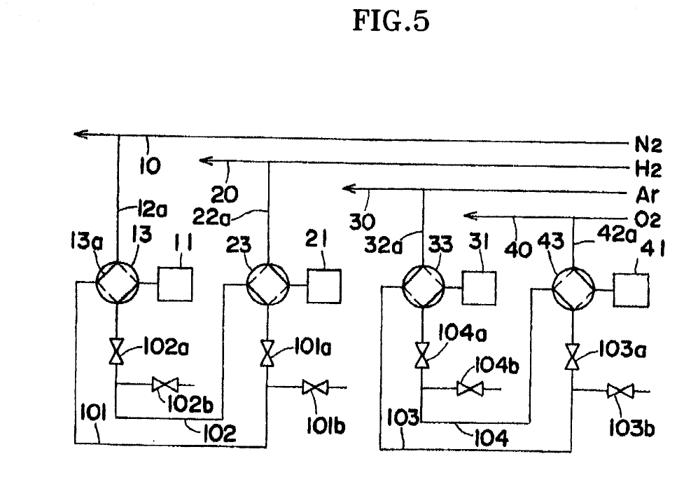

FIG. 5 is a systematic diagram showing the 2^{nd} embodiment of the present invention. In the following, the same constitutional elements as in the 1^{st} embodiment are explained with the same reference numbers.

In this analysis system, some of the 4 gases flowing the 4 gas routes may react each other; for example, the gas routes 10, 20, 30 correspond with nitrogen, hydrogen and argon, respectively, and the gas in the fourth gas route 40 corresponds with oxygen (O₂), which is reactive with hydrogen gas.

In this embodiment, the substitute analysis is carried out in a manner that the substitute analyses for hydrogen and oxygen are respectively in nitrogen analyzer 11 and argon analyzer 31 so that hydrogen and oxygen cannot be mixed.

That is, between the 4-way valve 13 of the nitrogen analyzer 11 and the 4-way valve 23 of the hydrogen analyzer 21, there is a nitrogen substitute analysis route 101 for introducing the nitrogen gas sampled in the analysis route 12a into the hydrogen analyzer 21, and a hydrogen substitute analysis route 102 for introducing the hydrogen gas sampled in the analysis route 22a into the nitrogen analyzer 11, which contain shutoff valves 101a, 102a and discharge valves 101b, 102b, respectively.

Further, between the 4-way valve 33 of the argon analyzer 31 and the 4-way valve 41 of the oxygen analyzer 41, there is an argon substitute analysis route 103 for introducing the argon gas sampled in the analysis route 32a into the oxygen analyzer 41, and an oxygen substitute analysis route 104 for introducing the oxygen gas sampled in the analysis route 42a into the argon analyzer 31, which contain shutoff valves 103a, 104a and discharge valves 103b, 104b, respectively.

Therefore, as shown in FIG. 5, by switching the 4-way valve 13 of the nitrogen analyzer 11 such that the internal pathway 13a thereof communicates with the analysis route 12a and the nitrogen substitute route 101, the nitrogen gas to be analyzed in the nitrogen analyzer 11 can be flowed through the nitrogen substitute route 101 toward the 4-way valve 23 of the hydrogen analyzer 21. Then, after completing the purge operation to discharge the nitrogen gas from the discharge valve 101b, by closing the discharge valve 101b, opening the shutoff valve 101a and switching the 4-way valve 23 of the hydrogen analyzer 21, the nitrogen gas can be introduced into the hydrogen analyzer 21 and analyzed therein.

Similarly, by controlling the respective 4-way valves, shutoff valves and discharge valves, each substitute analysis of the hydrogen gas, the argon gas and the oxygen gas are performed in the nitrogen analyzer 11, the oxygen analyzer 41 and argon analyzer 31.

As described above, because the sample gases may react with each other, such as oxygen and hydrogen, the nitrogen analyzer 11 and the argon analyzer 31 are selected as the substitute analyzers for the respective reactive gases so as to prevent the reactive gases from being mixed with each other, resulting in improving gas protection and analysis accuracy.

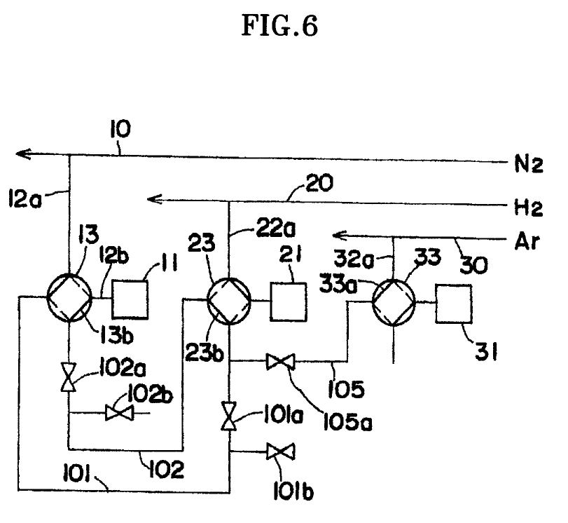

FIG. 6 is a system diagram showing the 3^{rd} embodiment of an analysis system according to the present invention, in which the argon analyzer 31 does not or cannot perform a substitute analysis for any other samples. That is, only an argon sending route 105 is mounted from the 4-way valve 33 of the argon analyzer 31, which is connected to the 4-way valve of the hydrogen analyzer 21 via the shutoff valve 105a.

In addition, as in the 2nd embodiment shown in FIG. 5, the 4-way valve 13 of the nitrogen analyzer 11 and the 4-way valve 23 of the hydrogen analyzer 21 are respectively provided with the nitrogen substitute analysis route 101 with the shutoff valve 101a and the discharge valve 101b and hydrogen substitute analysis route 102 with the shutoff 102a and discharge valve 102b, while the nitrogen substitute analysis route 101 is connected to the 4-way valve 23 after joining the argon sending route 105.

Therefore, the substitute analysis of the nitrogen gas sampled to the analysis route 12a from the gas route 10 can be performed in the hydrogen analyzer 21 by operating the 4-way valve 13, the shutoff valve 101a, the discharge valve 101b and the 4-way valve 23, the substitute analysis of the hydrogen gas sampled to the analysis route 22a from the gas route 20 can be performed in the nitrogen analyzer 11 by operating the 4-way valve 23, the shutoff valve 102a, the discharge valve 102b and the 4-way valve 13, and the substitute analysis of the argon gas sampled to the analysis route 32a from the gas route 30 can be performed in the hydrogen analyzer 21 by operating the 4-way valve 33, the shutoff valve 105a, and the 4-way valve 23.

Further, by forming the respective internal pathways of the 4-way valves 13, 23, 33, the argon gas sampled to the analysis route 32a from the gas route 30 can be flowed through the internal pathway 33a of the 4-way valve 33, the substitute analysis route at sending side 105, shutoff valve 105a, the internal pathway 23b of the 4-way valve 23, the hydrogen substitute analysis route 102, the shutoff valve 102a, the internal pathway 13b of the 4-way valve 13 and the analysis route 12b, into the nitrogen analyzer 11.

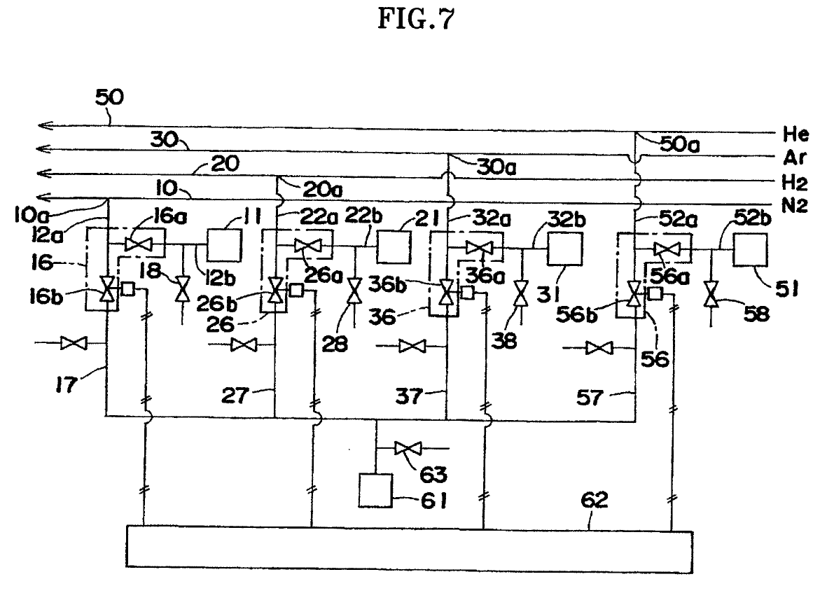

FIG. 7 is a system diagram showing the 4th embodiment of an analysis system according to the present invention, in which nitrogen, hydrogen, argon and helium (He) each flowing in the gas routes 10, 20, 30, 50 are constantly continuously monitored and analyzed in the 4 analyzers of the nitrogen analyzer 11, the hydrogen analyzer 21, the argon analyzer 31 and the helium analyzer 51, and a common analyzer 61 capable of analyzing the analysis object at each analyzer is further provided.

The respective analyzers 11, 21, 31, 51 for carrying out constant continuous monitoring and analyzing measure the concentration of trace oxygen in each gas, and the common analyzer 61 is an analyzer at least capable of measuring the concentration of trace oxygen, for example an atmosphere pressure ionization mass spectrometer.

Each of the analysis routes 12a, 22a, 32a, 52a for collecting sample from each of the gas routes 10, 20, 30, 50, is provided with 2-connected 3-way valves 16, 26, 36, 56, respectively as route switching means. One side valves 16a, 26a, 36a, 56a of the 2-connected 3-way valves are respectively connected to the analyzers 11, 21, 31, 51 via the analysis routes 12b, 22b, 32b, 52b and the other side valves 16b, 26b, 36b, 56b thereof are respectively connected to the common analyzer 61 via the substitute analysis routes 17, 27, 37, 57.

In addition, the valves 16b, 26b, 36b, 56b at the common analyzer side, which are automatically controlled by the sequencer 62, are respectively established so that only one of them is opened.

In a usual state, the valves 16a, 26a, 36a, 56a are always open, and nitrogen, hydrogen, argon and helium sampled to the analysis route 12a, 22a, 32a, 52a from the respective sampling points 10a, 20a, 30a, 50a are respectively introduced into the analyzers 11, 21, 31, 51 via the valves 16a, 26a, 36a, 56a and the analysis routes 12b, 22b, 32b, 52b, where the continuous monitoring and analyzing for oxygen as an impurity is carried out.

In addition, the valves 16b, 26b, 36b, 56b at the common analyzer side are opened in a predetermined sequence at regular time intervals, and a part of the sample from the opened valve flows through the substitute analysis route and is introduced into the common analyzer 61, in which various impurities including oxygen, for example, oxygen, carbon monoxide, carbon dioxide, methane, nitrogen, hydrogen, or the like are analyzed in the case of helium. Likewise, in the case of other gases, an identical analysis is carried out for the other gases.

As a result, the common analyzer 61 is in the state of carrying out the analysis of any of the gases.

In the constant continuous monitoring and analyzing, if any of the analyzers, for example, the nitrogen analyzer 11 outputs out-of-range data, the nitrogen gas supplied from the gas route 10 is switched first to the nitrogen gas for back-up and the valve 16b of the 2-connected-3-way, at the common analyzer side is opened prior to the other valves 26b, 36b, 56b, leading to the state in which the nitrogen gas is preferentially analyzed.

Moreover, the nitrogen gas with out-of-range output data is introduced into the common analyzer 61 from the outer sample introduction valve 63 via the separate route, and switched to the nitrogen gas for back-up in the gas route 10 with being analyzed, allowing the analysis for examining the cause of the data problem.

Accordingly, it can be crosschecked whether oxygen is mixed in the nitrogen gas. Further, this process can be used for examining the cause of air leakage by analyzing the other components.

If the cause of the oxygen mix in the nitrogen gas is found, the same analysis is continued after removing the cause, and then if there is no problem in the result data, the gas supply can be switched from the back-up nitrogen gas supply state to the normal nitrogen gas supply state.

In addition, even where the nitrogen analyzer 11 is out of order, by opening the valve 16b and performing a substitute analysis of nitrogen in the common analyzer 61 capable of constant continuous monitoring and analyzing, the nitrogen gas can be supplied continuously as usual. Meanwhile, by keeping the valve 16a in a closed state, it can be easily performed to remove the nitrogen analyzer 11 for repairs and to mount the nitrogen analyzer 11 after repairs, as well as exchange the analyzer itself.

As described above, the common analyzer 61 which analyzes each sample successively and switchably, can be used not only for cross-checking the analyzers respectively for constant continuous monitoring and analyzing, but also as a backup analyzer for promptly coping with breakdown or abnormality of the analyzers.

Further, by installing outer gas introduction shutoff valves 18, 28, 38, 58 at the introduction portion of the respective analyzer, even in the case of performing calibration by introducing a calibration gas into the respective analyzers from the shutoff valves, the 2-connected 3-way valves can be controlled, which make it possible for the common analyzer 61 to substitute the analysis while calibrating the analyzer, preventing gas supply and constant continuous monitoring and analyzing from being interrupted.

In the above respective embodiments, the numbers of the sampling points and analyzers and the kinds or properties of the samples are not limited, and thus the system may be constructed in a manner where the same gas flows through a plurality of routes,

In addition, any analyzer can be used for each of the analyzers.

As described above, according to the present invention, when the constant continuous monitoring analyzer produces out-of-range data or is out of order, a temporary back-up system is promptly operated, so that the cause of the problem may be quickly revealed. Further, the period of time during which monitoring is not performed at a sampling point corresponding to the analyzer with the data discrepancy can be shortened, resulting in minimizing the dead space of gas analysis.

Further, as a common calibration apparatus can be used, there is no need to provide separate calibration apparatuses for the respective analyzers.

What is claimed is:

1. An analysis system comprising:
a plurality of analyzers correspondingly mounted to a plurality of sampling points in which samples are respectively analyzed by said corresponding analyzers;
analysis routes for introducing the samples from said sampling points into said corresponding analyzers respectively;
substitute analysis routes at sending side for sending said samples to analyzers capable of analyzing same kinds of analysis objects as said samples out of said analyzers;
route switching means switchably connecting said analysis routes and said substitute analysis routes to said analyzers respectively;
substitute analysis route at receiving side being connected to at least one analyzer out of said analyzers and receiving said samples sent from said other analyzers via said route switching means.

2. The analysis system according to claim 1, wherein said route switching means is either a 3-way valve or 4-way valve.

3. The analysis system according to claim 1, wherein said substitute analysis route comprises a shutoff valve for shielding itself, and a discharge route communicating from said substitute analysis route to outside of the system and a shutoff valve for shielding said discharge route.

4. The analysis system according to claim 1, wherein said substitute analysis routes are connected between said analyzers analyzing the samples that do not react with one another.

5. An analysis system comprising:
a plurality of analyzers correspondingly mounted to a plurality of sampling points in which samples are respectively analyzed by said corresponding analyzer;
a common analyzer being capable of analyzing analysis objects in each of the analyzers;
analysis routes for introducing the samples from said sampling points into said corresponding analyzers;
substitute analysis routes for introducing said samples into said common analyzer;
route switching means switchably connecting said analysis routes and said substitute analysis routes to said analyzers respectively.

6. The analysis system according to claim 5, wherein said common analyzer is further provided with an outer sample introducing route to introduce thereto a sample from the outside, in addition to said substitute analysis routes.

7. An analysis method for analyzing each sample from a plurality of sampling points in a plurality of analyzers correspondingly mounted relative to said sampling points,
wherein, in case there occurs a discrepancy in an analyzer out of said analyzers, a sample designed to be analyzed by said analyzer is introduced into a substitute analyzer capable of analyzing a same kind of analysis object out of said other analyzers while a substitute analysis is effected by said substitute analyzer.

8. The analysis method according to claim 7, wherein said substitute analyzer alternatively analyzes the sample designed to be analyzed thereby and the sample designed to be analyzed in the analyzer with the discrepancy.

9. An analysis method for analyzing each sample from a plurality of sampling points in a plurality of analyzers correspondingly mounted relative to said sampling points,
wherein a common analyzer capable of analyzing analysis objects of the plurality of analyzers, is further provided in addition to said plurality of analyzers, and the samples to be analyzed in the analyzers are serially switched and introduced into the common analyzer which analyzes the samples switchably.

10. The analysis method according claim 9, wherein, in case there occurs a discrepancy in an analyzer out of said analyzers, the common analyzer preferentially analyzes a sample designed to be analyzed in said analyzer with the discrepancy.
